(19) United States
(12) Patent Application Publication
(10) Pub. No.: US 2025/0360646 A1
(43) Pub. Date: Nov. 27, 2025

(54) SET OF MILLING TOOLS AND METHOD FOR MANUFACTURING PANELS

(71) Applicant: UNILIN, BV, Wielsbeke (BE)

(72) Inventor: Jan DE RICK, Wielsbeke (BE)

(21) Appl. No.: 18/873,948

(22) PCT Filed: Jun. 15, 2023
(86) PCT No.: PCT/IB2023/056183

§ 371 Date: Dec. 11, 2024

(30) Foreign Application Priority Data
Jul. 1, 2022 (BE) 2022/5543

(51) Int. Cl. B27F 1/06; B27C 5/00

(52) U.S. Cl. CPC B27F 1/06; B27C 5/00

(57) ABSTRACT

A set of milling tools is for forming profiled edge regions on at least two opposite edges of panels, with a first and a second subset of milling tools. The first subset allows a first type of profiled edge region to be formed. The male coupling part and female coupling part are provided with horizontally acting locking surfaces. A first milling tool from the first subset is configured to form the horizontally acting locking surface of the male coupling part. The second subset allows a second type of profiled edge region to be formed, wherein the male coupling part and female coupling part are provided with horizontally acting locking surfaces. A first milling tool from the second subset is configured to form the horizontally acting locking surface of the male coupling part; and the first milling tools are configured to be mounted on the same drive shaft.

The present invention relates to a set of milling tools for forming profiled edge regions on at least two opposite edges of panels, as well as to a method for manufacturing panels, wherein at least one subset of said set of milling tools is used.

It is known, for example from WO 97/47834, WO 2006/103565 and WO 2011/014113, to form profiled edge regions on opposite edges of panels, by means of several successive cutting operations with rotating milling tools. These cutting operations may take place in a continuous milling machine, wherein the panel to be processed is moved through the machine and the rotating milling tools, which are arranged along the path of the panel, machine one or both edges thereof, which are parallel to the feed motion. It is known from WO 02/060691 to apply scraping tools instead of one or more of the rotating milling tools.

From WO 2008/010060 and WO 2021/260466, sets of milling tools are known which make it possible, with a minimum number of changes, to form optimized profiled edge regions of a well-defined type for panels of different thickness. WO '060 and WO '466 relate to sets of milling tools that make it possible to form profiled edge regions on two opposite edges, wherein these profiled edge regions are of the type that comprises a male coupling part and a female coupling part, which can be locked together by means of a turning motion and/or a horizontal sliding motion. Profiled edge regions of this kind may be provided both on the short and on the long pair of opposite edges of panels. According to another possibility, profiled edge regions of this kind may be provided on the long pair of opposite edges, while on the short pair of opposite edges, profiled edge regions are formed of the type that comprises a male coupling part and a female coupling part, which can be locked together by means of a downward motion. In this way a panel can be obtained that can be installed by means of a so-called fold-down motion, as is disclosed further in WO 01/75247. For the installation of a panel in a particular row of panels, a long edge of the panel to be installed is coupled to the long edge of an already installed panel of a previous row by means of a turning motion. A downward motion arises automatically on the short edges, which can be used for coupling a short edge to the short edge of one already installed from the new row. Hammering to obtain the final locked state on the short edge is not excluded here.

The present invention relates firstly to an alternative set of milling tools, wherein according to various preferred embodiments it is possible to change in a more economical manner between different types of profiled edge regions, and in particular between profiled edge regions that allow coupling by means of a turning motion and profiled edge regions that allow coupling by means of a downward motion.

For this purpose, the invention relates, according to its first independent aspect, to a set of milling tools for forming profiled edge regions on at least two opposite edges of panels, wherein the aforementioned profiled edge regions comprise coupling means that allow the respective edges to be coupled to each other, characterized in that the set of milling tools comprises both a first subset of milling tools and a second subset of milling tools, wherein this first subset and this second subset comprise milling tools, whether or not in common, and the subsets have the following characteristic features:
the aforementioned first subset allows a first type of profiled edge region to be formed, wherein the first type of profiled edge region comprises a male coupling part that can be fitted by means of a turning motion and/or a horizontal sliding motion into a female coupling part on the opposite edge, wherein the male coupling part and the female coupling part are provided with horizontally acting locking surfaces, which in the coupled state bring about at least locking in a horizontal direction perpendicular to the respective edges and in the plane of the coupled panels, wherein in the aforementioned coupled state, preferably locking is also obtained between the male and female coupling parts in a vertical direction perpendicular to the aforementioned plane, wherein a first milling tool from the first subset is configured to form a horizontally acting locking surface of the male coupling part of the first type of profiled edge region;
the aforementioned second subset allows a second type of profiled edge region to be formed, wherein the second type of profiled edge region comprises a male coupling part, which by means of a downward motion can be fitted into a female coupling part on the opposite edge, wherein the male coupling part and the female coupling part are provided with horizontally acting locking surfaces, which in the coupled state bring about at least locking in a horizontal direction perpendicular to the respective edges and in the plane of the coupled panels, wherein in the aforementioned coupled state, preferably locking is also obtained between the male and female coupling parts in a vertical direction perpendicular to the aforementioned plane, wherein a first milling tool from the second subset is configured to form a horizontally acting locking surface of the male coupling part of the second type of profiled edge region;
the aforementioned first tool from the first subset and the aforementioned first tool from the second subset comprise mutually different cutting edges; and
both the first milling tool from the first subset and the first milling tool from the second subset are configured to be mounted on a drive shaft that has one and the same inclination with the horizontal plane, preferably to be mounted on the same drive shaft.

“A milling tool that is configured to form a particular portion of the profiled edge region” means that this milling tool has one or more profiled cutting portions, which correspond to the respective portion of the profiled edge region. “A milling tool that is configured to be mounted on a drive shaft with a certain inclination” means that the aforementioned correspondence during milling is only attained when the milling tool is mounted on a drive shaft with the specified inclination, or with the specified range of inclination.

It is to be noted that a milling operation carried out with a set of milling tools according to the invention, or with a subset thereof, preferably takes place with the decorative side of the panels directed downwards, namely positioned against the feed chain of a continuous milling machine. When characteristic features of the panels are mentioned hereunder, an orientation will be assumed wherein the decorative side of the panels is directed upwards.

Because the first milling tool of the first subset, as well as of the second subset, are configured to be mounted on the same drive shaft, a change from the first type of profiled edge region to the second type of profiled edge region can be carried out easily. According to a first possibility, the drive shaft may be kept at the existing inclination. According to another possibility, a stop portion may be available, against which the drive shaft can be positioned directly or indirectly at the desired inclination. In that case, the drive shaft may be tilted, for example until an inclination is obtained in which the aforementioned first milling tools can be changed more safely, and tilted back to the original inclination with the aid of said stop portion. According to both possibilities, fine setting of the inclination of the respective drive shaft can be avoided.

Preferably, the horizontally acting locking surface of the male coupling part of both the first and of the second type of profiled edge region extends in the distal direction, seen from the panel, downwards at an angle from 55° to 80°. In this way, both for the first type and for the second type of profiled edge region, good locking can be obtained in the aforementioned horizontal direction, while the inclination of the drive shaft is such that it remains readily accessible for carrying out a change of milling tool. Then the angle at which the horizontally acting locking surface of the male coupling part of the first and the second type of profiled edge region extends may be identical or almost identical.

According to a particular embodiment, the horizontally acting locking surface of the male coupling part of the first and the second type of profiled edge region extends in the distal direction downwards at an angle that is mutually different, wherein the difference is 5° or less. The possibility of obtaining a slight difference in angle is useful for optimization of the locking strength in the horizontal direction. Preferably, the angle at which the horizontally acting locking surface is associated with the male coupling part of the second type of profiled edge region, is greater. Nevertheless, it remains possible, according to the invention, to obtain the respective locking surfaces on the basis of the aforementioned first milling tools of the first and the second subset, mounted on a drive shaft with the same inclination.

Preferably the aforementioned inclination of the drive shaft to the horizontal is between 10 and 35°. Said inclination is optimum for obtaining locking surfaces, as described above, which, for example in the distal direction, extend downwards at an angle, whether or not identical, between 55 and 80°.

According to a particularly preferred embodiment, the male coupling part and the female coupling part of both the first type of profiled edge region and of the second type of profiled edge region are provided with vertically acting locking surfaces, preferably formed by an upward-facing surface of the male coupling part and a downward-facing surface, interacting therewith, of the female coupling part. Preferably, the aforementioned first subset comprises a second milling tool that is configured to form a vertically acting locking surface of the male coupling part of the first type of profiled edge region, and the aforementioned second subset comprises a second milling tool that is configured to form a vertically acting locking surface of the male coupling part of the second type of profiled edge region, preferably in each case a vertically acting locking surface that is directed upwards and can interact with a downward-facing surface of the female coupling part of the respective types of profiled edge region. Preferably, the aforementioned second tool from the first subset and the aforementioned second tool from the second subset comprise mutually different cutting edges, and both the second milling tool from the first subset and the second milling tool from the second subset are configured to be mounted on a drive shaft that has one and the same inclination with the horizontal plane, preferably to be mounted on the same drive shaft. It is clear that the present particularly preferred embodiment contributes to the restricting of the time required for changing the milling tools when changing over from production of panels with the first type of profiled edge region to production of panels with the second type of profiled edge region. It should further be noted that a set of milling tools with said second milling tools also has independent inventive qualities, regardless of whether the first milling tools as described on the basis of the first aspect must necessarily be configured to be mounted on a drive shaft that has an identical inclination with the horizontal plane.

Preferably, the vertically acting locking surface of the male coupling part of the first and the second type of profiled edge region extends in the distal direction downwards at an angle that is mutually different, wherein the difference is 10° or more. This allows optimization of the vertical locking strength depending on the type of profiled edge region. Preferably the aforementioned angle is greater for the male coupling part of the second type of profiled edge region. Nevertheless, it remains possible to obtain the respective vertically acting locking surfaces on the basis of the aforementioned second milling tools of the first and the second subset, mounted on a drive shaft with the same inclination.

Preferably, the male coupling part of both the first and the second type of profiled edge region can be fitted into an identically formed female coupling part. As a result, it is barely necessary, if at all, to change milling tools for forming the female coupling part on change-over from the first type of profiled edge region to the second type, or vice versa. Preferably, the set of milling tools also comprises at least one third subset of milling tools that allows said female coupling part to be formed on the aforementioned opposite edge. In the present preferred embodiment, it is to be noted that the respective female coupling part may be combined with male coupling parts with locking surfaces that extend at a mutually different angle. In this case, the female coupling part and/or the male coupling part preferably have an elastically bendable portion. This elastically bendable portion can accommodate the different angle, so that with both male coupling parts, good locking is still obtained in the horizontal direction. The aforementioned elastically bendable portion may for example be a projecting lip of the respective female coupling part. When the female coupling part is configured as a groove flanked by an upper groove lip and a lower groove lip, the elastically bendable portion is preferably at least formed by the lower groove lip. This lower groove lip may then project in the distal direction beyond the aforementioned upper lip and/or may be provided with one or more elasticity grooves or recesses, which increase flexibility.

In connection with the foregoing preferred embodiment, it is further noted that, preferably, the downwards directed surface of the female coupling part that can interact with the vertically acting locking surface of the male coupling part, and so also functions as a vertically acting locking surface, may be different depending on whether it relates to interaction with the vertically acting locking surface of the male coupling part of the first or the second type of profiled edge region.

Preferably, the set of milling tools is suitable for forming profiled edge regions on a first and on a second pair of opposite edges of rectangular, elongated panels, wherein the aforementioned first to third subset is suitable for forming the profiled edge regions of the first pair, preferably a pair of short opposite edges, and wherein the set further comprises a fourth and fifth subset of milling tools, wherein the fourth and fifth subsets are suitable for forming a male coupling part, or respectively a female coupling part on the second pair of opposite edges, preferably on the pair of long opposite edges. Preferably, the profiled edge regions of the long pair of opposite edges comprise a male coupling part that can be fitted, by means of a turning motion and/or a sliding motion, into a female coupling part, wherein the male coupling part and female coupling part are provided with horizontally acting locking surfaces, which in the coupled state bring about at least locking in a horizontal direction perpendicular to the respective edges, wherein in the aforementioned coupled state, preferably locking is also obtained between the male and female coupling parts in a vertical direction perpendicular to the aforementioned plane.

By changing over, on the short pair of opposite edges, from the first type of profiled edge region, to the second type of profiled edge region, while for example the profiled edge region of the long pair of opposite edges is kept the same, it is possible to change over, with a minimum of changes of milling tools, from panels that are installed on the basis of only turning motions and/or horizontal sliding motions, to panels that can be installed on the basis of a so-called fold-down motion. These manners of installation are very common, and a manufacturer of panels, such as floor panels, often feels compelled to offer both. With the present invention, change of production between the two can be carried out more economically.

Preferably, the male coupling part of both the first type of profiled edge region and of the second type of profiled edge region can be fitted into the female coupling part of the second pair of opposite edges. On the basis of the present preferred embodiment, a very versatile panel can be offered, which is also suitable for forming coverings, such as floor coverings, with patterns, such as a herringbone pattern. Preferably, the male coupling part of the second pair of opposite edges can be fitted into the female coupling part of the first pair of opposite edges.

Preferably, the male coupling part of the second pair of opposite edges is identical or almost identical to the male coupling part of the first type of profiled edge region.

Preferably, the female coupling part of the second pair of opposite edges is identical or almost identical to the female coupling part that can interact with the male coupling part of the second type of profiled edge region.

It is clear that the set of milling tools, besides the aforementioned milling tools of the first and second subset, may comprise yet other milling tools, such as milling tools of the aforementioned third, fourth and/or fifth subset. Other possibilities for additional milling tools are:
one or more additional profile milling tools. Thus, for example, for forming the male coupling part of the second type of profiled edge region, an additional milling tool may be used for forming an undercut in a proximal surface on the underside of this male coupling part;
one or more finish milling tools. The final upper edge of the panel can be formed with said finish milling tool;
one or more roughing milling tools. With this roughing milling tool, an amount of material can be removed prior to application of the first and/or second milling tool of the first and/or the second subset of milling tools. In this way, the forces on the first and/or the second milling tool can be limited, and so too can the wear of these milling tools;
one or more milling tools for forming a lowered edge region, such as a chamfer, on the upper edge of the panel.

It is clear that the invention, with the same aim, according to a second independent aspect, also relates to a method for manufacturing panels, with at least one subset from a set of milling tools with the characteristic features of the first aspect of the invention and/or the preferred embodiments thereof. The method preferably comprises the step of changing at least the first milling tool of the first subset with the first milling tool of the second subset, for example with a view to changing the type of profiled edge region to be obtained on the respective pair of opposite edges, for example the short pair of opposite edges of a rectangular, elongated floor panel. Preferably, no changes are made for the milling tools that provide the female coupling part on the opposite edge and/or for the milling tools that provide the long pair of opposite edges with profiled edge regions.

According to a particular embodiment, the method further comprises the step of bringing, into an active position, an additional profile milling tool from a parking position in which it cannot engage with the panel, so that the additional profile tool, in the active position, can form a portion of the relevant type of profiled edge region.

It is also clear that the present invention also relates to a panel that has been obtained on the basis of a method with the characteristic features of the second aspect and/or the preferred embodiments thereof.

In general, it is further noted, with regard to all the aforementioned aspects, that the aforementioned panels may have one or more of the following properties:
the property that the panels comprise a substrate with a decorative top layer applied on top of it, wherein the aforementioned coupling parts are preferably in each case made as one piece with the material of the panel, more particularly with the substrate. The aforementioned decorative top layer preferably comprises a print. Said print may, with intermediate preparatory layers, be made directly on the substrate, or may be applied on a carrier layer, such as on a paper sheet or plastic film. Preferably, there is a transparent or translucent wear layer on top of said print. According to an alternative, the decorative top layer may also at least be formed by a wood veneer, stone veneer, textile, such as carpet or woven vinyl, or by a decorative powder mixture;
the property that the panels comprise a substrate of filled plastic composite, such as filled thermoplastic or thermosetting plastic. Thus, for example they may be so-called SPC panels (Stone Plastic Composite), which comprise a foamed or unfoamed substrate of thermoplastic, such as PVC (polyvinyl chloride), PE (polyethylene), PP (polypropylene), TPU (thermoplastic polyurethane) or PET (polyethylene terephthalate), which is filled with inorganic fillers such as CaCO₃. Alternatively, the panels may comprise a substrate of particles glued together, such as wood particles or cork particles. It may for example be an MDF or HDF (Medium or High Density Fibreboard) board or a wood chipboard. According to another alternative, the panels may comprise a substrate of wood, wooden laths or layers of wood. It may be for example a substrate of multiplex, or a so-called laminated core, assembled from wooden laths. According to another alternative the panels may comprise a mineral-based substrate, such as a cement fibreboard, a calcium silicate board, a plasterboard, or a magnesium oxide board;
the properties that the panels have a thickness between 3 and 18 mm. In the case of panels with a substrate of filled plastic composite, the panels preferably have a thickness between 3 and 7 mm. In the case of panels with one of the aforementioned alternative substrates, the panels preferably have a thickness between 6.5 and 15 mm;
the property that the panels have a length between 80 and 250 cm, and a width between 12 and 30 cm. In the case of panels with a substrate of filled plastic composite, the panels preferably have a length between 85 and 140 cm. In the case of panels with one of the aforementioned alternative substrates, the panels preferably have a length between 120 and 215 cm; and/or
the property that on one or more upper edges, the panel is provided with a lowered edge region, preferably in the form of a chamfer, wherein said lowered edge region preferably extends at least to a depth below the overall level of the top surface of a substrate. Preferably, the surface of the lowered edge region is provided with a decorative coating, either formed by an overall decorative top layer applied on the aforementioned substrate, or formed by a coating separate from the aforementioned overall decorative coating.

Furthermore, it is in general also noted, in relation to all the aforementioned aspects, that the aforementioned coupling parts may have one or more of the following properties:
the property that the male coupling part and the female coupling part of the first type of profiled edge region are configured substantially as, respectively, a tongue and a groove, flanked by an upper lip and a lower lip. The interaction of the tongue and the groove brings about, in the coupled state, preferably the aforementioned locking in the vertical direction. The horizontally acting locking surfaces are preferably formed respectively on a wall of a locking groove applied on the underside of the tongue, and on a wall of an upward-extending locking portion located on the upper side of the lower lip. Preferably, the lower lip extends in the distal direction beyond the upper lip. Preferably the aforementioned upward-extending locking portion is provided on that portion of the lower lip that extends beyond the distal end of the upper lip;
the property that the aforementioned horizontally acting locking surface of the male coupling part of the second type of profiled edge region is formed on a wall of a locking groove applied on the underside of the male coupling part. The female coupling part preferably has a projecting lip, wherein the horizontally acting locking surface of the female coupling part is preferably formed on a wall of an upward-extending locking portion located on the upper side of the projecting lip. Preferably, the projecting lip extends in the distal direction beyond the upper edge of the panel. Preferably, the aforementioned upward-extending locking portion is provided on that portion of the projecting lip that extends beyond the upper edge of the panel. Preferably, the male and female coupling part of the second type of profiled edge regions also have vertically acting locking portions. The vertically acting locking portions may be formed in various ways. Thus, for example they may comprise one or more undercuts, which interact with one or more projections. According to a first possibility, said undercut may be present on a proximal surface of the female coupling part and be intended to interact with a projection on a distal surface of the male coupling part.

According to a second possibility, said undercut and projection may be formed by the aforementioned horizontally acting locking surfaces, which in such a case are also vertically acting. According to a third possibility, said undercut may be formed on the end of the aforementioned projecting lip, with, in the coupled state, interacting therewith, a projection on the opposite wall of the male part;
the property that the male coupling part and the female coupling part of the first type of profiled edge region and/or the male coupling part and the female coupling part of the second type of profiled edge region are made as one piece in the same material as the rest of the panel; and/or the property that the female coupling part of the first and/or the second type of profiled edge region has, in the coupled state, an elastically bent portion, preferably respectively the aforementioned lower lip of the groove or the aforementioned projecting lip.

For the purpose of better illustrating the features of the invention, some preferred embodiments are described hereunder, as examples without any limiting character, referring to the appended drawings, in which:

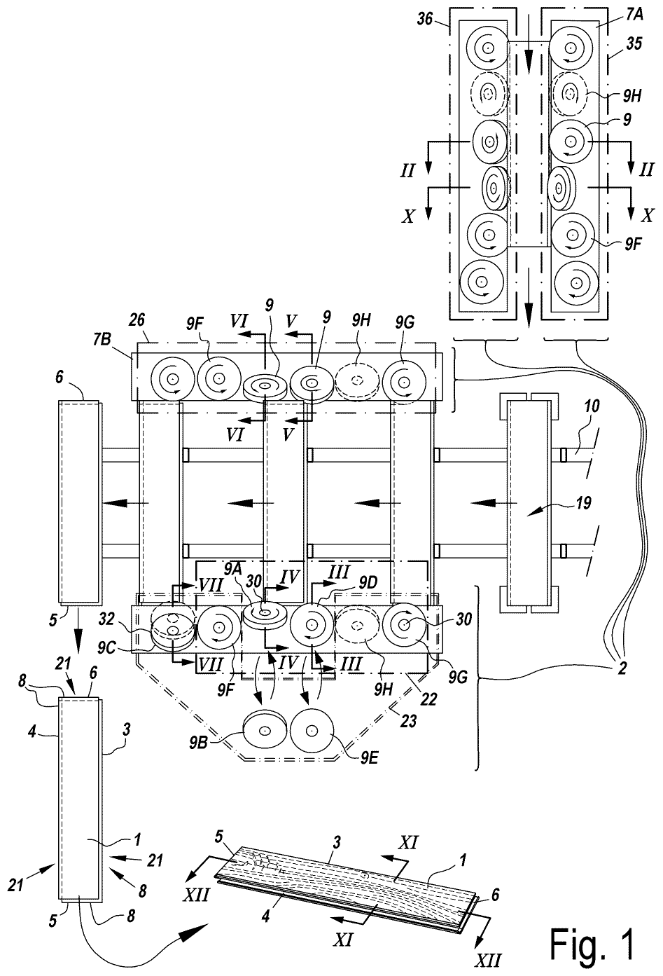

FIG. 1 shows schematically a method in which a set of milling tools according to the invention is used;

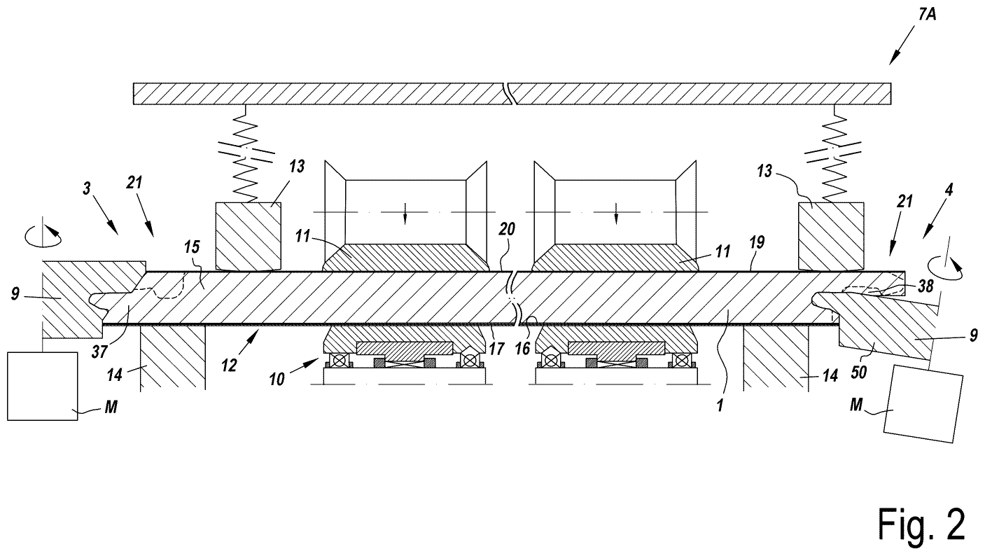

FIGS. 2 to 7 show cross-sections according to lines II-II; III-III; IV-IV; V-V; VI-VI and VII-VII shown in FIG. 1;

FIGS. 8 and 9 show, in a view similar to that of FIGS. 5 and 6, another method in which the set of milling tools from FIG. 1 is used;

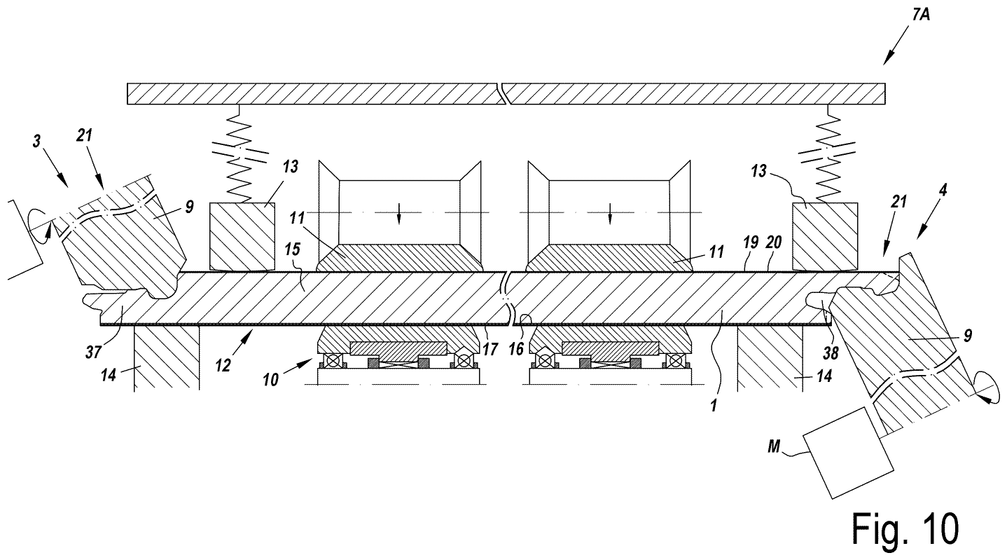

FIG. 10 shows a cross-section according to line X-X shown in FIG. 1;

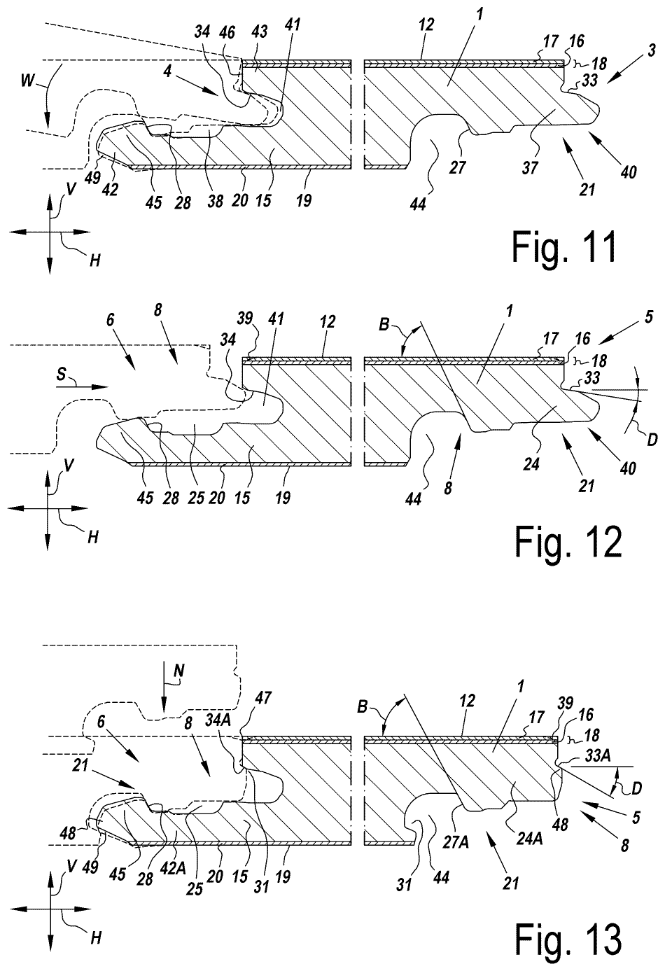

FIGS. 11 to 12 show, on a larger scale, a cross-section of the panels obtained by the method from FIG. 1, and according to lines XI-XI and XII-XII shown in FIG. 1; and

FIG. 13 shows, in a view similar to that in FIG. 12, another panel obtained by the method as illustrated in FIGS. 8 and 9.

FIG. 1 shows schematically how floor panels 1 can be obtained by a method in which a set of milling tools 2 according to the first aspect of the present invention is used. In the example shown, it relates to a method for manufacturing rectangular floor panels 1. Here, by means of two processing machines, more particularly continuous milling machines 7A-7B, the floor panels 1 are provided both on their long pair of opposite edges 3-4 and on their transverse or short pair of opposite edges 5-6, with profiled edge regions 8. Here, so-called “continuous milling” is employed. First, the panels 1 are moved with their long pair of opposite edges 3-4 over the mechanical cutting tools or milling tools 9. Then they undergo similar processing with their short or transverse opposite edges 5-6.

FIG. 2 shows how said panels 1 can be transported through the first processing machine 7A. For this purpose, the machine 7A, just like the machine 7B for processing the short pair of opposite edges 5-6, of the example, has a chain conveyor 10 and belts, more particularly upper belts 11. The panels 1 are upside down, i.e. with their decorative side 12 directed downwards, towards the chain conveyor 10. At the level of their edges 3-4, the panels 1 are pressed by means of pressure shoes 13 with their decorative side 12 onto the guide shoes 14.

The panels 1 shown consist of laminated material of the “DPL” type, but as stated in the introduction, it is clear that the invention is not limited to the manufacture of panels 1 that consist of said material.

The laminated material shown contains a core 15, a decorative layer 16, as well as a so-called overlay 17 or wear layer, wherein the decorative layer 16 and overlay 17 together form the top layer 18 and consist of carrier films impregnated with plastic, which are pressed on the core 15 and wherein the decorative layer 16 is also provided with a print or printed decor. The core 15 consists for example of a wood-based material, such as MDF or HDF. On their underside 19, which is oriented upwards here, during formation of the profiled edge regions 8, the panels 1 are provided with a balance layer 20, which consists of a resin-impregnated carrier film.

FIG. 2 shows that the profiled edge regions 8 to be formed comprise, on the long pair of opposite edges 3-4 of the floor panels 1, coupling means or coupling parts 21, with which two such panels 1 may be coupled to each other on the respective edges 3-4. Such is also the case for the profiled edge regions 8 to be formed, of the short pair of opposite edges 5-6.

The particular feature of the present invention is that the set of milling tools 2 comprises both a first subset 22 of milling tools 9 and a second subset 23 of milling tools 9.

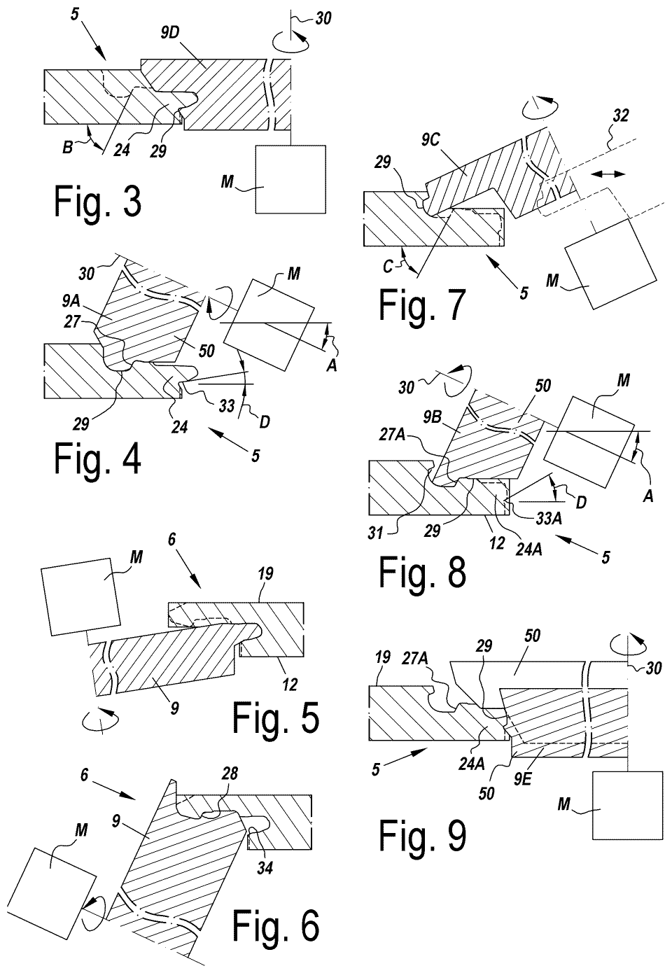

The first subset 22, as shown in FIGS. 3 and 4, allows the male coupling part 24 of a first type of profiled edge region to be formed, wherein the first type of profiled edge region comprises a male coupling part 24 that can be fitted by means of a turning motion W and/or a horizontal sliding motion S into a female coupling part 25 on the opposite edge 6, as is further illustrated in FIGS. 11 and 12. In the present case the first subset 22 is used in the continuous milling machine 7B, which machines the short opposite edges 5-6. In the same continuous milling machine 7B, the female coupling part 25 is also formed on the opposite short edge 5, such as by means of a third subset 26 of milling tools 9, as shown in FIGS. 5 and 6.

In the continuous milling machine 7B, a male coupling part 24 and a female coupling part 25 are obtained on the short opposite edges 5-6 and are provided with horizontally acting locking surfaces 27-28 which, in the coupled state, bring about at least locking in a horizontal direction H perpendicular to the respective edges and in the plane of the coupled panels 1. In the example, in the aforementioned coupled state, locking between the male coupling part 24 and female coupling part 25 is also obtained in a vertical direction V perpendicular to the aforementioned plane. FIG. 4 clearly shows that a first milling tool 9A from the first subset 22 is configured to form the horizontally acting locking surface 27 of the male coupling part 24 of the first type of profiled edge region.

The second subset 23, as shown in FIGS. 7 to 9, allows the male coupling part 24A of a second type of profiled edge region to be formed, wherein the second type of profiled edge region comprises a male coupling part 24A that can be fitted by means of a downward motion N into a female coupling part 25 on the opposite edge 6. In the present case, the second subset 23 is used as an alternative to the first subset 22 in the continuous milling machine 7B that machines the short edges 5-6. The female coupling part 25 on the opposite short edge 6 is configured identically to the female coupling part 25 of the first type of profiled edge region, and is shown in FIGS. 5 and 6. Consequently, this female coupling part 25 may be formed on the basis of the aforementioned third subset 25 of milling tools 9.

By means of the second subset 23 and third subset 26 of milling tools 9, in the continuous milling machine 7B, on the short opposite edges 5-6, a male coupling part 24A and female coupling part 25 are thus obtained, provided with horizontally acting locking surfaces 27A-28 which, in the coupled state, bring about at least locking in a horizontal direction H perpendicular to the respective edges 5-6 and in the plane of the coupled panels 1. In the example, in the aforementioned coupled state, locking is also obtained between the male coupling part 24A and female coupling part 25 in a vertical direction V perpendicular to the aforementioned plane. As shown in FIG. 9, a first milling tool 9B from the second subset 23 is configured to form the horizontally acting locking surface 27A of the male coupling part 24A of the second type of profiled edge region.

FIGS. 4 and 9 clearly show that the first tool 9A from the first subset 22 and the first tool 9B from the second subset 23 comprise different cutting edges 29, and that both the first milling tool 9A from the first subset 22 and the first milling tool 9B from the second subset 23 are configured to be mounted on a drive shaft 30 that has one and the same inclination A with the horizontal plane, i.e. in this case to be mounted on the same drive shaft 30. The inclination A of the drive shaft 30 with the horizontal plane is in this case about 25 degrees. The locking surface 27 of the male coupling part 24 of the first type of profiled edge region extends in the distal direction at an angle B of 65°, while the locking surface 27A of the male coupling part 24A of the second type of profiled edge region extends in the distal direction at an angle C of 62°.

It is clear that the aforementioned drive shafts 30 are driven by a motor M, preferably because the drive shaft 30 is formed by the motor shaft.

FIGS. 1 and 7 also show that the second subset 23 comprises an additional profile milling tool 9C for forming an undercut 31 in a proximal surface on the underside of the male coupling part 24A of the second type of profiled edge region. This additional profile milling tool 9C may be placed in a parking position 32 or inactive position, i.e. a position in which it cannot engage with the panel 1, when the first subset 22 is used. This parking position 32 does not necessarily need to be different from the position that the respective milling tool 9C occupies when using the second subset 23, i.e. in the forming of the male coupling part 24A of the second type of profiled edge region. The geometry of the cutting edge 29 of this additional profile milling tool 9C is namely such that it does not interfere with, or otherwise detract from, the geometry of the first type of profiled edge region.

FIGS. 3 to 9 also show that the male coupling part 24-24A and the female coupling part 25 of both the first type of profiled edge region and of the second type of profiled edge region are provided with vertically acting locking surfaces 33-33A-34-34A. These are in this case formed by an upward-facing surface 33-33A of the male coupling part 24-24A and, interacting therewith, a downward-facing surface 34-34A of the female coupling part 25. It is noted once again that the panels 1 in FIGS. 3 to 9 are shown with their decorative side 12 directed downwards, so that said upward-facing surfaces 33-33A of the male coupling part 24-24A mentioned here are directed downwards in the figures, and vice versa.

The aforementioned first subset 22 comprises a second milling tool 9D that is configured to form a vertically acting locking surface 33 of the male coupling part 24 of the first type of profiled edge region, and the aforementioned second subset 23 comprises a second milling tool 9E that is configured to form a vertically acting locking surface 33A of the male coupling part 24A of the second type of profiled edge region. It relates in each case to a vertically acting locking surface 33-33A that is directed upwards and can interact with a downward-facing surface 34-34A of the female coupling part 25 of the respective types of profiled edge region. The aforementioned second tool 9D from the first subset 22 and the aforementioned second tool 9E from the second subset 23 comprise mutually different cutting edges 29. Both the second milling tool 9D from the first subset 22 and the second milling tool 9E from the second subset 23 are configured to be mounted on a drive shaft 30, which has one and the same inclination with the horizontal plane. In this case they are configured to be mounted on the same drive shaft 30. The associated drive shaft 30 is in this case inclined at right angles to the horizontal plane.

The respective vertically acting locking surface 33-33A of the male coupling part 24A of the first and the second type of profiled edge region extends in the distal direction downwards at an angle D that is mutually different, wherein the difference is 10° or more. In the example, the vertically acting locking surface 33 of the male coupling part 24 of the first type of profiled edge region extends in the distal direction downwards at an angle D of 9°, while the vertically acting locking surface 33A of the male coupling part 24A of the second type of profiled edge region extends in the distal direction downwards at an angle D of 30°.

FIGS. 1, 2 and 10 show that the set of milling tools 2 comprises a fourth subset 35 and a fifth subset 36, which are suitable for forming a male coupling part 37, or respectively a female coupling part 38, on the long pair of opposite edges 3-4. In the example, these milling tools 9 are suitable for forming a profiled edge region of the first type, identical, or at the very least similar, to the first type of profiled edge region described herein for the short pair of opposite edges 5-6.

The set of milling tools 2, shown in the figures, makes it possible, with a minimum of easy changes, to change over from production of panels 1 with the first type of profiled edge region to production of panels 1 with the second type of profiled edge region. More particularly, in the example, it is possible to change over from the configuration in FIG. 1, which relates to production of panels 1 with the first type of profiled edge region, to production of panels 1 with the second type of profiled edge region, by:
bringing the additional milling tool 9C of FIG. 7 into the active position;
replacing the first milling tools 9A-9B, i.e. changing from the first milling tool 9A from the first subset 22, as shown in FIG. 4, to the first milling tool 9B from the second subset 23, as shown in FIG. 9. It is not necessary to adjust the inclination A of the drive shaft 30. However, from safety considerations, it is possible to work with a stop portion, as explained in the introduction, but this is not illustrated here; and
replacing the second milling tools 9D-9E, i.e. changing from the second milling tool 9D from the first subset 22, as shown in FIG. 3, to the second milling tool 9E from the second subset 23, as shown in FIG. 8. It is not necessary to adjust the inclination of the drive shaft 30. A vertical orientation of the drive shaft 30 is in this case ideal for carrying out a safe change.

Of course, it is possible that a fine adjustment of the positions of the first, second and additional milling tools 9A-9B-9C-9D-9E is necessary on change-over. This fine adjustment may be limited in time and effort because the number of milling tools changed is limited and because the inclination of the drive shafts 30 does not have to be adjusted, or because it is possible to work with a stop portion.

It is also to be noted that, as shown here, the set of milling tools 2, besides the already mentioned milling tools from the first to the fifth subset inclusive, may further comprise one or more finish milling tools 9F and/or one or more roughing milling tools 9G and/or one or more milling tools 9H for forming a lowered edge region 39, such as a chamfer. These milling tools 9F-9G-9H do not need to be changed on change-over from production of panels 1 with the first type of profiled edge region to production of panels 1 with the second type of profiled edge region.

FIG. 11 shows the resultant profiled edge regions on the long pair of opposite edges 3-4. In the example, when using the aforementioned first subset 22 of milling tools, these are identical to the resultant profiled edge regions of the short pair of opposite edge regions 5-6, shown in FIG. 12. This configuration allows a male coupling part 24 of the short pair of opposite edges 5-6 to be coupled with the female coupling part 38 of the long pair of opposite edges, and vice versa. With this configuration of profiled edge regions, particular laying patterns may be obtained.

It is to be noted that the panels 1 in FIGS. 11 and 12, as well as in FIG. 13, are floor panels, which are shown here in the orientation of use, i.e. with the decorative side 12 facing upwards.

The male coupling parts 24 and female coupling parts 25 of the first type of profiled edge region are configured substantially as a tongue 40 and a groove 41, respectively. The groove 41 is in this case delimited by a lower lip 42 and an upper lip 43, wherein in the example the lower lip 42 to be formed extends beyond the upper lip 43. The male and female coupling parts 24-25 that are shown result, in a coupled state of at least two of the aforementioned floor panels 1 both in a horizontal direction H and in a vertical direction V, in mutual locking of the respective panels 1. The interaction of the tongue 40 and the groove 41, in the coupled state, brings about the aforementioned locking in the vertical direction V. The horizontally acting locking surfaces 27-28 are formed respectively on a wall of a locking groove 44 applied on the underside of the tongue 40, and on a wall of an upward-extending locking portion 45 located on the upper side of the lower lip 42. The lower lip 42 extends in the distal direction beyond the upper lip 43, and the aforementioned upward-extending locking portion 45 is provided on that portion of the lower lip 42 that extends beyond the distal end 46 of the upper lip 43.

FIG. 13 shows that the aforementioned horizontally acting locking surface 27A of the male coupling part 24A of the second type of profiled edge region is formed on a wall of a locking groove 44 applied on the underside of the male coupling part 24A. The female coupling part 25 has a projecting lip 42A, wherein the horizontally acting locking surface 28 of the female coupling part 25 is formed on a wall of an upward-extending locking portion 45 located on the upper side of the projecting lip 42A. The projecting lip 42A extends in the distal direction beyond the upper edge 47 of the panel 1. In this case the aforementioned upward-extending locking portion 45 is provided on that portion of the projecting lip 42A that extends beyond the upper edge 47 of the panel 1. As already mentioned above, the male coupling part 24A and female coupling part 25 of the second type of profiled edge regions comprise vertically acting locking portions 33A-34A. The vertically acting locking portions 33A-34A comprise one or more undercuts 31, which interact with one or more projections 48. In the example, a said undercut 31 is present on a proximal surface of the female coupling part 25 and is intended to interact with a projection 48 on a distal surface of the male coupling part 24A. Another pair of interacting undercut 31 and projection 48 is formed respectively on the end of the aforementioned projecting lip 42A and on the opposite wall of the male coupling part 24A.

The coupling parts 21 of both the pair of long opposite edges 3-4, and of the pair of short opposite edges 5-6 are, in the examples, made as one piece in the same material as the rest of the panel 1.

According to a particular embodiment, shown with a dashed line 49 in FIGS. 12 and 13, the female coupling part 25 of the first and/or the second type of profiled edge region may, in the coupled state, have an elastically bent portion, for example, such as illustrated here, the aforementioned lower lip 42 of the groove 41 or the aforementioned projecting lip 42A. It is also shown with a dashed line that the panels may, on their upper edges 47, be provided with a lowered edge region 39, for example, such as here, in the form of a chamfer.

Referring to FIG. 9, it is also noted that a milling tool 9-9A-9B-9C-9D-9E may comprise several teeth 50 that are mounted on the perimeter of the respective milling tool. In the case of the second milling tool 9E from the second subset 23, from the example shown in FIG. 9, the several teeth 50 have mutually different cutting edges 29. These teeth 50 are preferably mounted alternately on the perimeter of the milling tool 9E. Possibly, the distance measured along the drive shaft 30 between the various teeth 50 may be altered, in order to compensate for wear of the respective cutting edges.

The present invention is by no means limited to the embodiments described as examples and illustrated in the figures, but said set of milling tools and/or method may be implemented in various ways without departing from the scope of the invention.

1.-15. (canceled)

16. A set of milling tools for forming profiled edge regions on at least two opposite edges of panels,
wherein the aforementioned profiled edge regions comprise coupling means that allow the respective edges to be coupled to each other,
wherein the set of milling tools comprise both a first subset of milling tools and a second subset of milling tools,
wherein this first subset and this second subset comprise milling tools, whether or not in common, and the subsets have the following characteristic features:
the aforementioned first subset allows a first type of profiled edge region to be formed,
wherein the first type of profiled edge region comprises a male coupling part, which can be fitted by means of a turning motion and/or a horizontal sliding motion into a female coupling part on the opposite edge,
wherein the male coupling part and female coupling part are provided with horizontally acting locking surfaces which, in the coupled state, bring about at least locking in a horizontal direction perpendicular to the respective edges and in the plane of the coupled panels,
wherein a first milling tool from the first subset is configured to form the horizontally acting locking surface of the male coupling part of the first type of profiled edge region;
the aforementioned second subset allows a second type of profiled edge region to be formed, wherein the second type of profiled edge region comprises a male coupling part, which can be fitted by means of a downward motion into a female coupling part on the opposite edge,
wherein the male coupling part and female coupling part are provided with horizontally acting locking surfaces which, in the coupled state, bring about at least locking in a horizontal direction perpendicular to the respective edges and in the plane of the coupled panels,
wherein a first milling tool from the second subset is configured to form the horizontally acting locking surface of the male coupling part of the second type of profiled edge region;
the aforementioned first tool from the first subset and the aforementioned first tool from the second subset comprise mutually different cutting edges; and
both the first milling tool from the first subset and the first milling tool from the second subset are configured to be mounted on a drive shaft that has one and the same inclination with the horizontal plane.

17. The set of milling tools in accordance with claim 16, wherein both the first milling tool from the first subset and the first milling tool from the second subset are configured to be mounted on the same drive shaft.

18. The set of milling tools in accordance with claim 16, wherein the horizontally acting locking surface of the male coupling part of both the first and the second type of profiled edge region extends in the distal direction downwards at an angle from 55° to 80°.

19. The set of milling tools in accordance with claim 16, wherein the horizontally acting locking surface of the male coupling part of both the first and the second type of profiled edge region extends in the distal direction downwards at a mutually different angle, wherein the difference is 5° or less.

20. The set of milling tools in accordance with claim 16, wherein the aforementioned inclination of the drive shaft to the horizontal is between 10° and 35°.

21. The set of milling tools in accordance with claim 16, wherein the male coupling part of both the first and the second type of profiled edge region can be fitted into an identically formed female coupling part, and in that the set of milling tools also comprises at least one third subset of milling tools, which allows said female coupling part to be formed on the aforementioned opposite edge.

22. A set of milling tools in accordance with claim 16, wherein the male coupling part and the female coupling part of both the first type of profiled edge region and of the second type of profiled edge region provided with vertically acting locking surfaces, formed by an upward-facing surface of the male coupling part and a downward-facing surface, interacting therewith, of the female coupling part,
wherein the aforementioned first subset comprises a second milling tool that is configured to form a vertically acting locking surface of the male coupling part of the first type of profiled edge region, and the aforementioned second subset comprises a second milling tool that is configured to form a vertically acting locking surface of the male coupling part of the second type of profiled edge region, in each case a vertically acting locking surface that is facing upwards and can interact with a downward-facing surface of the female coupling part of the respective types of profiled edge region, and
wherein the aforementioned second tool from the first subset and the aforementioned second tool from the second subset comprise mutually different cutting edges, and both the second milling tool from the first subset and the second milling tool from the second subset are configured to be mounted on a drive shaft that has one and the same inclination with the horizontal plane.

23. The set of milling tools in accordance with claim 22, wherein both the second milling tool from the first subset and the second milling tool from the second subset are configured to be mounted on the same drive shaft, for example a drive shaft that is oriented at right angles to the horizontal plane.

24. The set of milling tools in accordance with claim 22, wherein the vertically acting locking surfaces of the male coupling part of the first and the second type of profiled edge region extend in the distal direction downwards at an angle that is mutually different, wherein the difference is 10° or more.

25. The set of milling tools in accordance with claim 22, wherein the aforementioned first milling tools instead of being configured to be mounted on a drive shaft that has one and the same inclination with the horizontal plane, are configured to be mounted on one or more drive shafts that have a mutually different inclination.

26. The set of milling tools in accordance with claim 16, wherein the set is suitable for forming profiled edge regions on a first pair of opposite edges and on a second pair of opposite edges of rectangular, elongated panels,
wherein the aforementioned first to third subset is suitable for forming the profiled edge regions of the first pair of, and
wherein the set further comprises a fourth and fifth subset of milling tools,
wherein the fourth and fifth subset are suitable for forming a male coupling part, or respectively a female coupling part, on the second pair of opposite edges.

27. The set of milling tools in accordance with claim 26, wherein the male coupling part of both the first type of profiled edge region and of the second type of profiled edge region can be fitted into the female coupling part of the second pair of opposite edges.

28. The set of milling tools in accordance with claim 27, wherein the male coupling part of the second pair of opposite edges can be fitted into the female coupling part of the first pair of opposite edges.

29. The set of milling tools in accordance with claim 27, wherein the male coupling part of the second pair of opposite edges is identical or almost identical to the male coupling part of the first type of profiled edge region.

30. The set of milling tools in accordance with claim 27, wherein the female coupling part of the second pair of opposite edges is identical or almost identical to the female coupling part that can interact with the male coupling part of the second type of profiled edge region.

31. A method for manufacturing panels, wherein at least one subset from a set of milling tools is used,
wherein said set of milling tools comprise both a first subset of milling tools and a second subset of milling tools,
wherein this first subset and this second subset comprise milling tools, whether or not in common, and the subsets have the following characteristic features:
the aforementioned first subset allows a first type of profiled edge region to be formed, wherein the first type of profiled edge region comprises a male coupling part, which can be fitted by means of a turning motion and/or a horizontal sliding motion into a female coupling part on the opposite edge,
wherein the male coupling part and female coupling part are provided with horizontally acting locking surfaces which, in the coupled state, bring about at least locking in a horizontal direction perpendicular to the respective edges and in the plane of the coupled panels,
wherein in the aforementioned coupled state, also locking between the male coupling part and female coupling part is obtained in a vertical direction perpendicular to the aforementioned plane,
wherein a first milling tool from the first subset is configured to form the horizontally acting locking surface of the male coupling part of the first type of profiled edge region;
the aforementioned second subset allows a second type of profiled edge region to be formed,
wherein the second type of profiled edge region comprises a male coupling part, which can be fitted by means of a downward motion into a female coupling part on the opposite edge,
wherein the male coupling part and female coupling part are provided with horizontally acting locking surfaces which, in the coupled state, bring about at least locking in a horizontal direction perpendicular to the respective edges and in the plane of the coupled panels,
wherein in the aforementioned coupled state also locking between the male coupling part and female coupling part is obtained in a vertical direction perpendicular to the aforementioned plane, wherein a first milling tool from the second subset is configured to form the horizontally acting locking surface of the male coupling part of the second type of profiled edge region;
the aforementioned first tool from the first subset and the aforementioned first tool from the second subset comprise mutually different cutting edges; and
both the first milling tool from the first subset and the first milling tool from the second subset are configured to be mounted on the same drive shaft.

32. The method according to claim 31, wherein the method comprises the step of changing at least the first milling tool of the first subset with the first milling tool of the second subset.

33. The method according to claim 31, wherein the horizontally acting locking surface of the male coupling part of both the first and the second type of profiled edge region extends in the distal direction downwards at an angle from 55° to 80°, and at a mutually different angle, wherein the difference is 5° or less.

34. The method according to claim 31, wherein the aforementioned inclination of the drive shaft to the horizontal is between 10 and 35°.

35. A panel obtained by a method wherein at least one subset from a set of milling tools is used, said set of milling tools comprising both a first subset of milling tools and a second subset of milling tools,
wherein this first subset and this second subset comprise milling tools, whether or not in common, and the subsets have the following characteristic features:
the aforementioned first subset allows a first type of profiled edge region to be formed,
wherein the first type of profiled edge region comprises a male coupling part, which can be fitted by means of a turning motion and/or a horizontal sliding motion into a female coupling part on the opposite edge,
wherein the male coupling part and female coupling part are provided with horizontally acting locking surfaces which, in the coupled state, bring about at least locking in a horizontal direction perpendicular to the respective edges and in the plane of the coupled panels,
wherein in the aforementioned coupled state, also locking between the male coupling part and female coupling part is obtained in a vertical direction perpendicular to the aforementioned plane,
wherein a first milling tool from the first subset is configured to form the horizontally acting locking surface of the male coupling part of the first type of profiled edge region;
the aforementioned second subset allows a second type of profiled edge region to be formed, wherein the second type of profiled edge region comprises a male coupling part, which can be fitted by means of a downward motion into a female coupling part on the opposite edge,
wherein the male coupling part and female coupling part are provided with horizontally acting locking surfaces which, in the coupled state, bring about at least locking in a horizontal direction perpendicular to the respective edges and in the plane of the coupled panels,
wherein in the aforementioned coupled state also locking between the male coupling part and female coupling part is obtained in a vertical direction perpendicular to the aforementioned plane,
wherein a first milling tool from the second subset is configured to form the horizontally acting locking surface of the male coupling part of the second type of profiled edge region;
the aforementioned first tool from the first subset and the aforementioned first tool from the second subset comprise mutually different cutting edges; and
both the first milling tool from the first subset and the first milling tool from the second subset are configured to be mounted on a drive shaft that has one and the same inclination with the horizontal plane.
